(19) United States
(12) Patent Application Publication
(10) Pub. No.: US 2024/0227086 A1
(43) Pub. Date: Jul. 11, 2024

(54) SYSTEMS AND METHODS FOR DETERMINING WELD QUALITY AND PROPERTIES IN RESISTANCE SPOT WELDING

(71) Applicant: UT-Battelle, LLC, Oak Ridge, TN (US)

(72) Inventors: Wei Zhang, Oak Ridge, TN (US); Zhili Feng, Oak Ridge, MI (US); Dali Wang, Oak Ridge, TN (US); Jian Chen, Oak Ridge, TN (US); Hassan Ghassemi-Armaki, Warren, MI (US); Blair Carlson, Warren, MI (US)

(21) Appl. No.: 18/545,435

(22) Filed: Dec. 19, 2023

Related U.S. Application Data
(60) Provisional application No. 63/437,370, filed on Jan. 6, 2023.

(51) Int. Cl. B23K 31/12

(52) U.S. Cl. CPC B23K 31/125; B23K 11/11

(57) ABSTRACT

Rapid and accurate quality prediction of resistance spot welding (RSW) for the automotive and other transportation sectors. A machine learning system and method incorporates materials information, e.g., material classification, surface coating, dimensions, stack-up conditions, etc., welding schedule, e.g., current, voltage, force, electrode displacement, welding equipment conditions, e.g., electrode information, water cooling, etc., as well as in-process measurable signals, e.g., heat generation, acoustic emission, etc., and offline weld attribute measurements to determine weld quality metrics. The system and method can also determine a set of resistance spot welding input parameters to produce a desired weld quality.

### CROSS-REFERENCE TO RELATED APPLICATIONS

This invention was made with government support under Contract No. DE-AC05-00OR22725 awarded by the U.S. Department of Energy. The government has certain rights in the invention.

### FIELD OF THE INVENTION

The present invention relates to automated machine learning systems and methods, and more specifically to automated machine learning systems and methods for determining resistance spot weld quality and other resistance spot welding properties.

### BACKGROUND OF THE INVENTION

Resistance spot welding is the primary assembly method in the automotive industry. The quality of the welds is critical to the crash resistance and performance of vehicles. Research has shown that the joint performance of spot welds strongly depends on weld processes, post-weld conditions, and weld structures/attributes however, the interdependencies of various factors are complex and difficult to understand and correlate. The complexity is further exacerbated by use of different stacking materials, especially with dissimilar material combinations.

All US automakers today perform destructive teardown evaluations. The very nature of destructive testing means only a few selected joints are sampled for quality. There are significant costs and risks associated with reworking and scrapping defective joined parts made between teardown tests.

There is a need for reliable and cost-effective nondestructive evaluation (NDE) technologies that can be used in high-volume auto structure manufacturing environments. Some nondestructive evaluation technologies have been explored, such as monitoring dynamic electrical signals, force, electrode displacement, e.g., indentation depth, during welding, ultrasonic inspection, computer visualization of electrode imprints, and infrared thermography. However, due to limitations in reliability, evaluation accuracy and difficulties in integration into autobody production assembly line, these technologies have not been broadly implemented in automotive production lines. For example, the operation of ultrasonic NDE usually requires contact between the transducer and the material surface with the application of a coupling gel at the interface. Furthermore, most of the existing ultrasonic NDE devices are handheld and limited to post-weld, offline applications with the inspection cycle being relatively long, which is unsuitable for a mass production environment.

### SUMMARY OF THE INVENTION

The present invention provides a system and method for automating the determination of weld quality based on resistance spot welding parameters using machine learning and artificial intelligence. To facilitate accurate machine learning, the resistance spot welding input parameters are categorized into resistance spot welding categories (e.g., weld schedule, weld attributes, base materials, coupon geometry, and other weld conditions). The system and method include a neural network that is trained on known resistance spot welding parameters from the resistance spot welding categories that produce known results (e.g., known peak load, extension at break, and total energy). For example, the neural network may be a deep neural network (“DNN”) that is trained on a resistance spot welding training dataset. Following training, the DNN is capable of performing the weld quality determination by using the trained model on new resistance spot welding datasets, where the datasets include values of input parameters from the resistance spot welding categories. In some embodiments, the system is configured to provide confidence-based probabilities regarding weld quality and possibly other numerical outputs related to the weld quality (e.g., peak load, extension at break, and total energy values).

In one embodiment, the present invention provides a software system and accompanying interface that uses physics-based resistance spot welding input parameters to determine weld quality, and to provide a numerical physics-based characterization of the factors that contribute to weld quality.

The present disclosure provides systems and methods that take a non-destructive machine learning approach to evaluating weld quality. Machine learning techniques ML techniques have been leveraged to develop optimized systems and effective decision making in many engineering and manufacturing fields. By constructing and training an expandible and unified resistance spot welding machine learning model a large amount of resistance spot welding experimental data can be analyzed with an emphasis on relationships between welding schedule, weld attributes, post-weld conditions, and joint performance, and to determine the influences on joint performance (e.g., post-weld baking).

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 illustrates an exemplary deep neural network system emphasizing categorized resistance spot welding input parameters and weld quality output parameters.

FIG. 2A-F illustrate exemplary input resistance spot welding parameters as well as output resistance spot welding parameters.

FIG. 3 illustrates an exemplary resistance spot welding deep neural network architecture.

FIGS. 4A-B illustrate box plots showing the population distribution for error of prediction for the weld mechanical properties.

FIG. 5 illustrates a representative block diagram of a system in accordance with an embodiment of the present disclosure.

FIG. 6 illustrates a regression analysis between measured and machine learning predicted peak load.

FIG. 7 illustrates a regression analysis between measured and machine learning predicted extension at break.

FIG. 8 illustrates a regression analysis between measured and machine learning predicted total energy.

FIG. 9 illustrates differences in peak load of an unbaked weld and corresponding paint baked weld.

FIG. 10 illustrates differences in extension at break of an unbaked weld and corresponding paint baked weld.

FIG. 11 illustrates differences in total energy of an unbaked weld and corresponding paint baked weld.

FIG. 12A illustrates a schematic of a finite element model of a coach peel weld specimen including geometry dimensions.

FIG. 12B illustrates a hardness informed model with nugget area mapped from cross-section geometry.

FIG. 13A illustrates thermal stress distribution in a single joint resistance spot weld specimen.

FIG. 13B illustrates variation of thermal stress in an intermetallic compound layer with varying thicknesses of steel plate under baking process.

FIG. 14A illustrates a plot of simulated stress distribution in a resistance spot weld composed of 1.2 mm AA6022 and 1.2 mm HDG LCS at the end of baking.

FIG. 14B illustrates variation of thermal stress in an intermetallic compound layer with varying thickness of steel plate under baking process.

FIG. 15 illustrates a representative flow diagram for utilizing a resistance spot welding deep neural network in accordance with the present disclosure.

### DESCRIPTION OF THE CURRENT EMBODIMENT

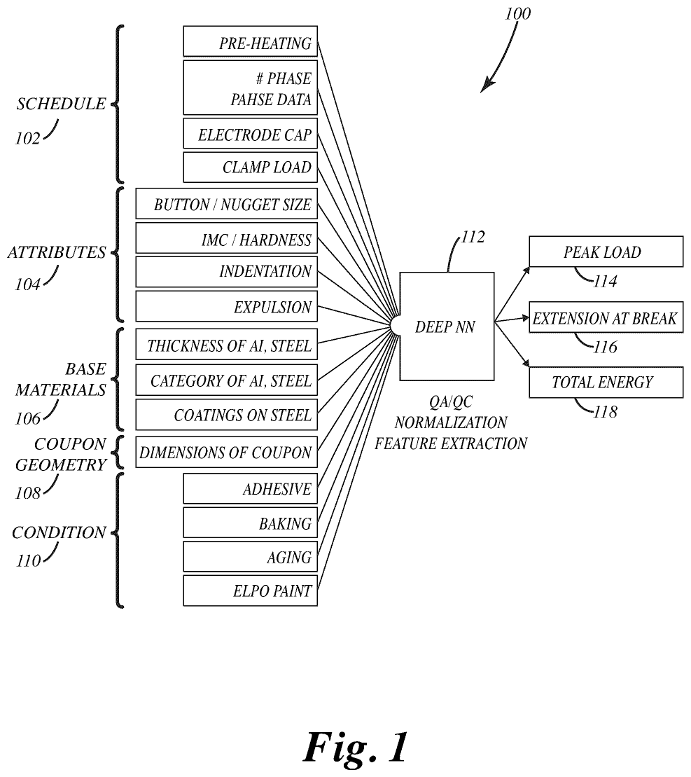

A resistance spot weld quality prediction system 10 and method in accordance with an embodiment of the present disclosure is shown in FIGS. 1-15. The system 10 includes hardware and software systems that are configured to use machine learning to, in some embodiments, provide automated review of resistance spot weld parameters to predict quality of a weld created using those specified input parameters. In other embodiments, machine learning is used to predict values for one or more input parameters that will produce a resistance spot weld with sufficient weld quality (e.g., above threshold output parameters). The systems and methods of the present disclosure utilize an expandable machine learning architecture with a unified neural network capable of training and learning based on a wide range of resistance spot welding parameters from different categories. Systems and methods in accordance with the present disclosure can be used to predict weld quality and/or input parameters under a variety of loading conditions and spot weld configurations. For example, embodiments can predict weld quality and characteristics for resistance spot welds between steel to steel, steel to aluminum, and aluminum to aluminum alloys produced by AC resistance spot weld machines and medium and high frequency DC resistance spot weld machines.

Put simply, once a trained resistance spot welding machine learning model is obtained, there are at least two potential applications. First, automakers strive to make welds that can achieve specified performance targets (e.g., high strength and high total energy as the outputs in the machine learning framework) for a certain material combination. With a suitably trained resistance spot welding machine learning model, the model can predict the range of input weld variables needed for making a weld with desired performance characteristics. Second, a trained (e.g., trained, tuned, or updated) machine learning model in accordance with the present disclosure can be used as a predictive tool to predict weld performance metrics for new given input weld variables, for example welding schedules, button size, etc. That is, the machine learning framework of the present disclosure can be two parts for building two types of weld attributes: performance and process weld attributes and performance-based weld attribute relationships. Users can enter either welding schedule parameters or weld attributes (e.g., button size) as inputs for the machine learning framework.

Before describing exemplary embodiments of systems and methods in accordance with various aspects of the present disclosure, it should generally be understood that the systems and methods of the present disclosure can include and can be implemented on or in connection with one or more computers, microcontrollers, microprocessors, and/or other programmable electronics that are programmed to carry out the functions described herein. The systems may additionally or alternatively include other electronic components that are programmed to carry out the functions described herein, or that support the computers, microcontrollers, microprocessors, and/or other electronics. The other electronic components can include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in another manner, whether combined into a single unit or distributed across multiple units. Such components may be physically distributed in different positions in an embedded system, or they may reside in a common location. The artificial intelligence or machine learning models and supporting functionality can be integrated into electronic components that work in concert with a resistance spot welding system. In some embodiments, the deep neural network systems can be provided on a general-purpose computer, special purpose computing components (such as graphics processing units (GPUs)) and/or within a dedicated hardware framework. When physically distributed, the components may communicate using any suitable serial or parallel communication protocol, such as, but not limited to SCI, WiFi, Bluetooth, FireWire, I2C, RS-232, RS-485, and Universal Serial Bus (USB).

The present invention will now be described in more detail with reference to FIGS. 1-5 and 15. As noted above, the present invention may be implemented as a software system implemented in appropriate hardware (as discussed elsewhere herein) with an accompanying user interface that uses categorized resistance spot welding parameters to determine (e.g., predict) the quality of spot weld that will be produced by a spot welding system utilizing those inputs, and, in one embodiment, to provide a numerical representation of weld quality. For example, in the FIG. 1 embodiment, the system provides weld quality prediction in the form of peak load, extension at break, and total energy values. In other embodiments, the system can be configured to vary one or more input parameters and determine values of those variable input parameters that will provide a threshold weld quality (e.g., above threshold values of peak load, extension at break, and total energy).

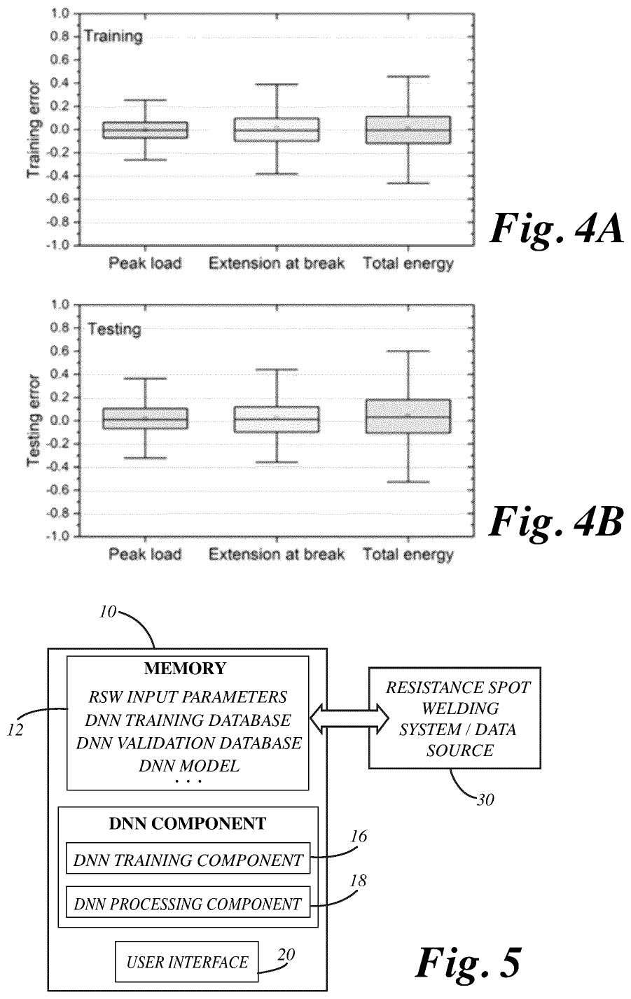

Referring to FIG. 5, an exemplary system 10 of the present disclosure includes a data storage system 12 (e.g., memory) configured to store a deep neural network (DNN) model along with various data and parameters. For example, the memory can store resistance spot weld input parameters, resistance spot weld output parameters, deep neural network training dataset(s), deep neural network validation dataset(s). The DNN model can be configured to receive (e.g., be processed with) resistance-spot welding (RSW) input parameters from an RSW system or data source 30, where the input parameters are categorized into a set of RSW categories (e.g., base materials, attributes, coupon geometries, condition, and schedule) that the DNN model can use to predict joint-performance metrics of a joint of two materials to be produced by an RSW system 30 using the input parameters. The exemplary system 10 can include a computer system configured to retrieve a pretrained DNN model from the data storage system 12, access (i) sets of experimental input parameters used by the RSW system to produce respective joints of pair-wise materials, and (ii) sets of experimental joint-performance metrics corresponding to the produced joints, normalize the experimental input parameters and the experimental joint-performance metrics in a manner expected by the DNN model.

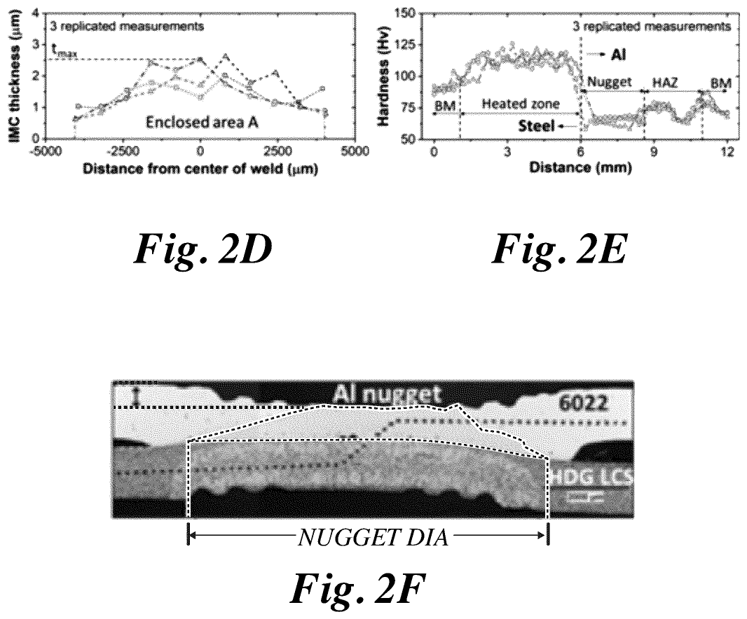

In some embodiments, the DNN can be trained from scratch, for example, utilizing a set of resistance spot welding training data that produces a known labeled weld quality (e.g., specific values for peak load, extension at break, and total energy). A suitable network architecture can be selected (e.g., convolutional, recurrent, feedforward) and its structure (number of layers, types of layers, number of neurons per layer) can be selected. For example, FIG. 3 illustrates an exemplary deep neural network structure 300 for weld quality prediction. The DNN structure includes a set of RSW input parameters from five categories 302 mapped to an input layer 310, three hidden layers 320 (with Rectified Linear Units (ReLUs) 322 and dropout 324 layers), and an output layer 330 mapped to three output parameters 340 that characterize weld quality. The deep neural network's weights and biases can be initialized randomly or utilizing a well-known initialization technique. Next, an optimization algorithm or loss function can be selected that will adjust the weights during training to minimize the loss function, which quantifies the difference between the network's predictions and the actual data. During initial training, input data can be fed through the network layer by layer to make predictions and loses can be computed by comparing the prediction with the actual label. Backpropagation can also be performed to calculate gradients of the loss with respect to each weight using the chain rule, moving backwards through the network. Throughout training, the weights and biases can be adjusted in a direction that reduces the loss using a selected optimization algorithm. The rectified linear units and dropout functions can be utilized to reduce overfitting.

Referring to FIG. 5, an exemplary resistance spot welding machine learning system 10 can train, tune, or retrain the DNN model using a DNN training component 16, the normalized experimental input parameters and the normalized experimental joint-performance metrics, and store the updated/trained DNN model in the data storage system 12. This training process will be discussed in more detail below. The DNN training component 16 can also be utilized for testing, or alternatively a separate DNN testing component can be included for testing a test validation dataset, e.g., a subset of the training dataset not used in model training.

The exemplary system 10 can include a user interface 20 and controller circuitry (e.g., DNN processing component 18), configured to receive one or more new input parameters to be included in the input parameters that, when used by the RSW system to join two materials, cause the RSW system to produce a new joint having two or more target joint-performance metrics, retrieve, from the data storage system, the retrained DNN model and use it to determine remaining input parameters to be used by the RSW system in conjunction with the new input parameters to produce the new joint having the target joint-performance metrics, and instruct the RSW system 30 to use as input parameters the new input parameters and the determined input parameters to join the two materials.

In general, the present disclosure emphasizes: 1) categorizing and labeling welding input and output data/parameters; 2) using an expandable machine learning architecture with a unified neural network configured to train on and learn a wide range of material combinations and resistance spot welding conditions; and 3) training and validating strategies of the machine learning architecture.

For illustrative purposes, data from a particular mechanical test—the coach peel test, is utilized to illustrate systems and methods of the present disclosure. The disclosed systems and methods can be used to predict weld quality and weld properties under other loading conditions and spot weld configurations. For explanation purposes, this disclosure provides several exemplary use cases for resistance spot welds between steel to steel, steel to aluminum, and aluminum to aluminum alloys produced by AC resistance spot weld machines and medium and high frequency DC resistance spot weld machines.

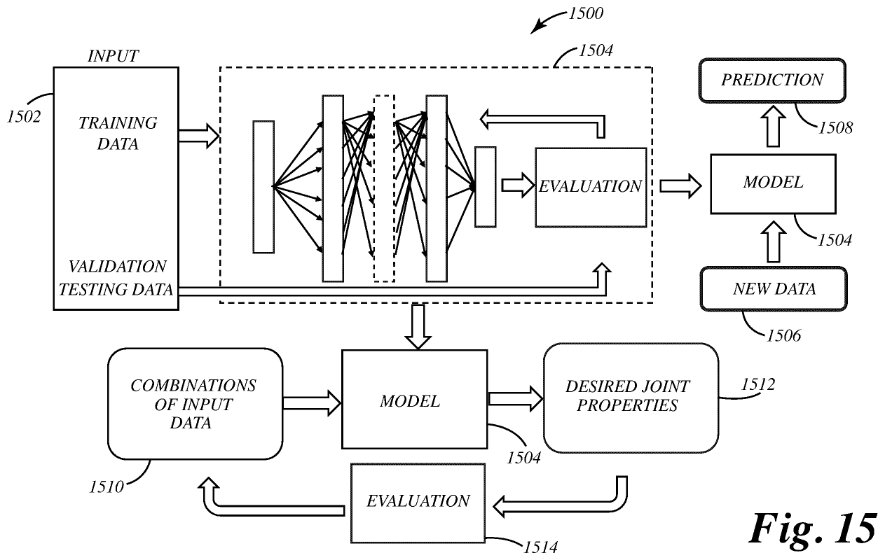

FIG. 15 illustrates a method 1500 of utilizing a resistance spot welding deep neural network in accordance with the present disclosure to identify a set of weld parameters that achieve a performance target. Put simply, FIG. 15 illustrates a high-level exemplary flow diagram of how a spot resistance welding machine learning model can facilitate identifying weld parameters to meet a target weld quality level. This process also illustrates how the machine learning model can facilitate a search for improved weld parameters that provide enhanced weld performance.

Referring to FIG. 15, a supervised algorithm of deep neural network (DNN) associates weld joint performance with various weld parameters (e.g., parameters from the categories 102, 104, 105, 108, 110). The DNN model is configured to have a unified architecture that is expandable so that one training strategy can be applied for different material combinations and weld stack-ups. Then, the DNN model can analyze a RSW data set, which can include weld stack-ups made from a wide range of material thicknesses (e.g., Al alloys and steel alloy combinations, as well as steels with different types of surface coatings). The DNN model can identify high dimensional correlations among weld attributes and mechanical properties of RSW joints. Moreover, the machine learning model can identify the material thickness-dependent effects of post-weld baking on mechanical performance of the dissimilar Al-steel spot welds. As discussed below, to acquire a mechanistic understanding of baking effects as revealed by the machine learning model, a three-dimensional finite element model can be used to simulate the dissimilar Al-steel RSWs under baking process.

In operation, training data and validation testing data 1502 can be fed into the machine learning model 1504 to train the neural network. Then, in one use case, new data 1506 (e.g., in the form of a set of some, but perhaps not all, values of input parameters) can be fed into the model 1504 to provide a weld quality prediction 1506 for a weld generated using those input parameters. In another use case, combinations of input parameters 1510 are fed into the model 1504 that produce a set of desired joint properties 1512, which can then be evaluated 1514 (e.g. by a DNN processing component 18) and a new set of combination of input data 1510 can be fed into the model 1504 to modify the desired weld joint properties 1512. This process can be iterated to effectively identify a set of combination of input parameters 1510 that provide a set of desired weld joint properties 1512, not just to predict the weld quality. For example, a set of desired weld joint properties may include a peak load>=750.0 N and total energy>=14.5 J for a material combination not yet tested experimentally.

In summary, process control can be achieved with regard to welding two materials by identifying manufacturing conditions that generate desired weld features and joint quality, and then controlling the manufacturing conditions to achieve desired joint quality. A machine learning framework can model complex relationships between resistance spot welding parameters (e.g., weld attributes and joint properties) without computational models. One machine learning model representative of multiple response variables can be developed, and corresponding process conditions can be predicted. The machine learning framework can make predictions for which sets of parameters will provide defect-free, high performance resistance spot weld joints. Due to the nature of machine learning, the machine learning model can reveal unusual correlation of certain parameters (e.g., baking/adhesives) on joint performance as illustrated by the example provided below.

### Welding Input and Output Data Categorization and Labeling

Embodiments of the disclosed systems and methods use a collection of resistance spot welding parameters to train (or retrain/tune) a machine learning system to establish a quantitative correlation for weld quality and weld property prediction. In the current embodiment, the resistance spot welding parameters are categorized into five categories: welding schedule, weld attributes, base materials, coupon geometry, and welding equipment. In alternative embodiments, the machine learning system can be trained based upon additional, different, or fewer categories of welding parameters. The welding parameters can be represented in the machine learning model as floating-point numbers, integers, representative labels, or other data types based on the nature of the parameters.

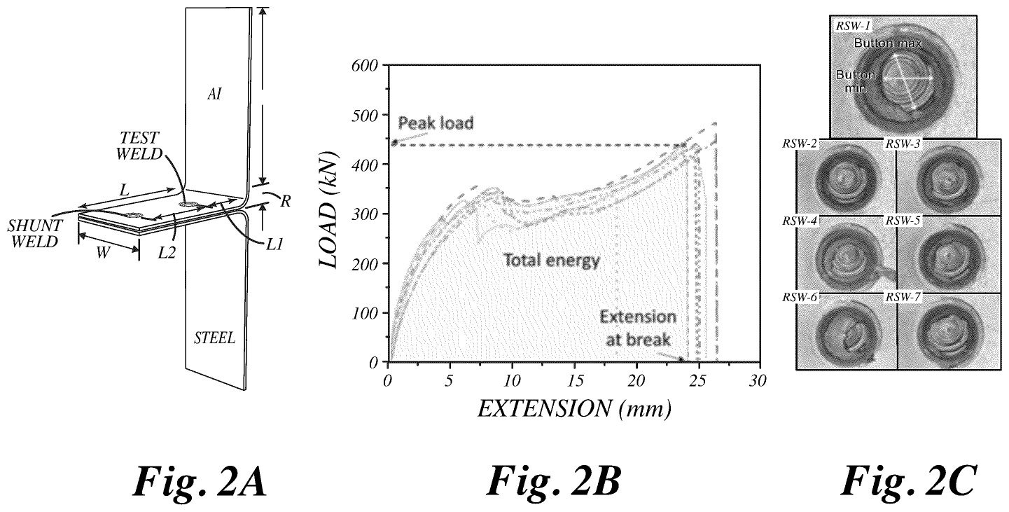

FIG. 2A-F illustrates exemplary input resistance spot welding parameters (also referred to as input variables) as well as output resistance spot welding parameters (also referred to as output variables). FIG. 2A illustrates geometry dimensions of a coach peel specimen. A coach peel specimen generally refers to a specific type of test specimen used to evaluate the peel strength of resistance spot welding, particularly in the automotive industry. This type of specimen is designed to mimic the peeling stress that occurs in joints in real-world applications, like in the assembly of vehicles. The coach peel specimen typically involves the welding of two metal substrates. One end of the assembly is then peeled back at a controlled angle, usually using a testing machine. This allows for the measurement of the force required to peel the substrates apart, providing an indication of the weld's peel strength. Specific dimensions and features of the test specimen are illustrated in FIG. 2A (e.g., Height (H), Radius (R), Length (L), Width (W), L1 (Length of welded area), L2 (Length of free end of the specimen). FIG. 2B illustrates a graph of coach peel properties. While the coach peel test is destructive and therefore is preferably avoided during weld quality prediction using the systems and methods of the present disclosure, the underlying data from coach peel tests (and potentially other destructive tests) can be informative to training (or retrain) the underlying neural network model. FIG. 2C illustrates various button sizes and shapes for different resistance spot welds and how the button minimum parameter and button maximum parameter can be measured. FIG. 2D illustrates various weld parameters associated with intermetallic compound (IMC) characteristics. FIG. 2E illustrates various weld parameters associated with hardness. FIG. 2F illustrates various weld parameters associated with material indentation.

The machine learning system (e.g., deep neural network) can be configured to predict weld quality based on a variety of different input RSW parameters. Each of these input parameters can be categorized into an RSW input parameter category. In the current embodiment, there are five RSW input parameter categories:
Weld Schedule Input Parameter Category 102;
Weld Attribute Input Parameter Category 104;
Base Materials Input Parameter Category 106;
Coupon Geometry Input Parameter Category 108; and
Other weld Condition Input Parameter Category 110.

Examples of resistance spot welding input parameters within each of these five categories will now be discussed in detail.

### Weld Schedule Input Parameters

Weld schedule input parameters can include pre-heating parameters, welding cycle parameters (e.g., number of current phases, current intensity, welding duration), electrode cap parameters, and clamp load parameters, to name a few.

Pre-heating parameters refers to the set of parameters associated with pre-heating the materials before welding. Pre-heating can reduce thermal shock to the materials, help in achieving more uniform heating during the welding process, and reduce the risk of cracking or distortion in the weld area. Specific examples of pre-heating parameters can include current intensity, heat time, and cool time of the pre-heat stage.

Welding cycle parameters refer to the number of distinct periods during which current is applied in the welding process. Each phase or cycle can have different parameters (like current intensity and duration). Sequencing them can impact the quality of the weld. Specific examples of welding cycle parameters can include, for example, for each phase/cycle, the number of pulses, initial current intensity, ending current intensity, heat and cool time per pulse, and cool time over the course of all pulses of the weld stage or cycle.

Electrode cap parameters can include various characteristics of the electrode cap. Electrode caps concentrate the welding current at the desired point. The characteristics of the electrode cap can impact consistency and quality of weld. Specific examples of electrode cap parameters can include shape, dimension, size, and condition of the anode and cathode caps.

Clamp load parameters refer to the force with which the workpieces are held together during the welding process. That is, the electrode force applied on the stacking material sheets. Clamping can impact electrical and thermal contact between the workpieces during the weld, which in turn can impact weld quality and consistency.

### Weld Attribute Input Parameters

Weld attribute input parameters can include button parameters, nugget parameters, intermetallic compound parameters, hardness parameters, indentation parameters, and expulsion parameters, to name a few examples.

Button parameters are parameters associated with weld button. After a spot weld is made, if the welded pieces are forcefully separated, the nugget often pulls out a portion of the metal from one or both of the sheets, leaving a weld button. Weld button parameters can characterize the button and be indicative of weld quality, for example, button parameters such as diameter, area, minimum length, maximum length, and average length across the button can be indicative of weld quality. Exemplary button size maximum and minimum are illustrated by fractographies of Al-steel welds in FIG. 2C.

Nugget parameters refer to characteristics about the weld formed between two pieces of metal being joined by resistance spot welding. The nugget is created due to the heat generated by electrical resistance, which melts the metal in a small area. Nugget size (e.g., nugget diameter) is one parameter that generally refers to the diameter or cross-sectional area of the melted and re-solidified zone. The size of the nugget is one indicator of strength of the weld. An example nugget diameter measurement is illustrated in FIG. 2F.

Material indentation parameters refer to deformation or impression made on the surface of a material during the weld. For example, material indentation formed due to pressure and heat during an exemplary resistance spot weld between steel and aluminum is shown in the cross-section view of FIG. 2F. The material indentation parameters can refer to specific characterizations of the material indentation, for example the Aluminum indentation is labeled in FIG. 2F. In some welds, such as Al-steel resistance spot welds, the indentation emphasis is on locations in the Al sheet, and indentations in steel sheet are not used as model inputs. However, in alternative embodiments, the indentations in the steel sheet can be used as model inputs. As another example, in Al—Al and steel-steel spot welds, the indentation is generally symmetric, and indentation parameters derived from one side of material can be used as model input.

During resistance spot welding, the high temperature and pressure can lead to the formation of intermetallic compounds (IMCs) at the interface of the metals being joined. This is particularly common when welding different types of metals, such as aluminum to steel. The presence of IMCs can influence weld quality. For example, a thin layer of IMCs can be beneficial for bonding, while a thick layer can make the weld brittle and prone to cracking. Accordingly, distribution and variation of IMCs (e.g., between Al and steel), including mean and maximum IMC thickness, width of its spatial distribution, enclosed area of IMC thickness-spatial distribution curve, can be a factor in weld quality and characteristics. FIG. 2D illustrates exemplary IMC parameters applicable to resistance spot welds between Al and steel alloys.

The hardness of the weld area, including the weld nugget, the heat-affected zone (HAZ), and base materials (BMs) can provide information about the weld's structural integrity and performance. As depicted in FIG. 2E, the hardness input parameters can include zone-based hardness for different locations of RSWs, including hardness of Al nugget, Al HAZ, Al base material, heated zone of steel, as well as the base material of steel.

Expulsion generally refers to ejection of molten material from the weld area during the welding process. Expulsion parameters can be informative about weld quality. In the current embodiment, expulsion is characterized by a representative label (sometimes referred to as a categorical variable), where, for example, 0, 1, and 2 represents that there is none, slight, and heavy expulsion, respectively.

### Base Material Input Parameters

Base material parameters can include thickness of the base materials being joined, particular base material properties, and any parameters associated with coatings on the base materials. Base material properties can include, for example, resistivity, Young's modulus, yield strength, ultimate tensile strength, elongation of both the materials being welded. For coating parameters, steel is often coated, for example with HDG, ZnNi, EG, or GA. Coating parameters can also include that that the base material is not coated (e.g., bare steel).

### Coupon Geometry Input Parameters

Coupon geometry refers to the shape, size, and specific dimensions of a test specimen, often referred to as a coupon. These coupons are small, standardized pieces of material cut from a larger piece or specifically fabricated to represent a welded joint that is being tested. The geometry of the coupon affects the results and interpretations of the tests conducted. Exemplary geometry dimensions of coach peel specimens, are shown in FIGS. 2A-B.

### Other Weld Condition Input Parameters

The weld condition input parameters can include adhesive parameters, baking parameters, aging parameters, and Electrophoretic Lacquer Over Paint (ELPO) parameters.

In some resistance spot welding applications, different types of adhesives (e.g., epoxies, acrylics, urethanes) can be utilized that have different properties and behaviors under the heat and pressure of spot welding. Adhesive specific parameters can include not only the type of adhesive, but strength of the adhesive before and after curing, heat resistance, conductivity, thickness, consistency, compatibility with the base materials, viscosity, and application method, to name a few exemplary parameters.

The baking process is to cure the coatings and adhesives after auto body parts are welded together. This step can help to achieve desired properties such as hardness, corrosion resistance, and adhesion. In the current exemplary embodiment, the baking temperature of 175 degrees Celsius was applied through the baking process. A baking parameter generally refers to a categorical variable such as 0 for non-baked and 1 for baked welds.

The aging period refers to the time interval after the welding process during which the properties of the welded joint stabilize. After welding, the metal at the joint may undergo metallurgical transformations that can affect the mechanical properties of the weld, such as strength, hardness, and ductility. The aging period generally refers to the time period to stabilize the weld.

### Resistance Spot Welding Output Parameters

While training or tuning the deep neural network on specific input parameters (e.g., selecting input parameters from each of the RSW categories) can provide enhanced weld quality prediction, the specific resistance spot weld output parameters can also impact the ultimate weld quality prediction. In the current embodiment, there are three resistance spot weld output parameters (peak load, extension at break, and total energy). However, in alternative embodiments, there may be different, additional, or fewer RSW output parameters.

Peak load refers to the maximum load or force that a welded joint can withstand before failing when subjected to a mechanical test. This parameter can be helpful in assessing the quality and strength of a spot weld. The resistance spot weld deep neural network predicts the peak load that can be applied to a weld created with the input parameters provided to the deep neural network before that weld would fail.

Extension at break generally refers to how much the welded joint can be stretched or elongated before it fails. This parameter can also be helpful in assessing the quality of a spot weld. The resistance spot weld deep neural network predicts the extension at break that can be applied to a weld created with the input parameters provided to the deep neural network before that weld would fail.

Total energy generally refers to the amount of energy consumed during the welding process. During the spotwelding process electrical energy is primarily used to generate heat through resistance at the joint between the materials being welded. This parameter can be helpful in assessing the quality of a spot weld. The resistance spot weld deep neural network predicts the total energy that will be consumed by a weld created with the input parameters provided to the deep neural network.

These resistance spot welding output parameters for the deep neural network collectively provide a suitable representation of the strength, deformability, and resistance to fracture of a resistance spot weld (i.e. weld quality). In some embodiments, these parameter values can be provided relative to a weld under a coach peel test, as shown in load-extension curves in FIG. 2B.

### Unified and Expandable Machine Learning Architecture

An exemplary machine learning model suitable for use with embodiments of the present disclosure has a unified architecture to cover a variety of input parameters and output parameters related to resistance spot welding.

In one aspect, the system and method utilizes a single neural network design and a single training strategy for different material combinations and weld stack-ups. Such a unified machine learning architecture avoids inconsistency and biased learning as the machine learning model expands to cover more weld stack-ups, weld schedules, base materials, welding conditions, etc. Such unified and expandable machine learning architecture makes it possible to guide resistance spot welding process development with untested materials, thickness, and other parameters.

One exemplary expandable machine learning architecture 100 with a unified neural network is illustrated in FIG. 1 and will now be discussed in detail. The input variables or parameters to the machine learning architecture include five categories (welding schedule 102, weld attributes 104, base materials 106, coupon geometry 108, and welding conditions 110). The input variables are represented in the machine learning architecture as either floating-point numbers or strings, based on the knowledge of welding physics. The input variables are normalized and fed into a multi-layer fully connected neural network 112 that predicts three outputs: peak load (N) 114, extension at break (mm) 116, and total energy (J) 118.

The design of the machine learning architecture can vary depending on application. In the current embodiment, the machine learning architecture is based on a 1) physics-guided data representation; 2) deep neural network design; and 3) a supervised learning training strategy. Alternative embodiments can utilize a different machine learning architecture.

The machine learning architecture is unified, meaning the architecture can handle a wide range of resistance spot welding data types within a single model. That is, there are no separate models for different stack-ups, e.g., no different machine learning design, no separate training, etc. Instead, one unified model architecture covers all resistance spot welds, meaning there is one unified data representation, one machine learning network design, and one training strategy. For example, a unified data representation provides consistency across data types. Various data types (e.g., text, images, numerical data, etc.) can be transformed into a format that can be uniformly understood and processed by the resistances spot welding machine learning system, which simplifies the data processing pipeline.

The machine learning architecture is expandable. This means that the machine learning architecture can accommodate the addition of new input parameters. For example, different input parameters (e.g., new base material parameters, weld scheduling parameters, and other weld condition parameters, can be accommodated as they become available). Because the machine learning architecture is expandible it has the versatility to guide process development for unknown combinations (e.g., new materials and/or thicknesses).

FIG. 3 illustrates one embodiment of a multi-layer fully connected deep neural network architecture in accordance with the present disclosure. It contains an input layer whose size is determined by the total number of inputs and a 3-node output layer that predicts the peak load, extension at break, and total energy. The neural network can have several (e.g., 3 to 5) hidden layers of gradually reduced sizes. In embodiments with a larger input layer, more hidden layers between the input and output layers may be included. A rectified linear unit (ReLU) layer and dropout layer may be attached to some or each hidden layer to improve the network's training stability.

### Machine Learning Model Training and Validation Strategies

In some embodiments, a pretrained deep neural network for predicting weld quality can be obtained or stored in memory. In other embodiments, a deep neural network can be trained from scratch on a relatively small amount of data. In either case, an iterative approach can be used to gradually incorporate new inputs and expand the machine learning architecture. For example, in some embodiments, a deep neural network can be trained from scratch on a single material stack-up with sufficient data samples that only include input parameters from the weld attribute category. The dataset can be split into training and testing datasets (e.g., with an 8:2 ratio). More data samples can be added over time to retrain or tune the machine learning architecture. For example, more data can be provided with different steel thicknesses and coatings, and the input space (both the number of neurons in the input layer as well as the number of neurons in the downstream layers) can be increased to accommodate the additional input parameters (and input parameter categories) thereby expanding the machine learning flow and architecture. This can be further iterated by training with additional data samples (e.g., with different aluminum types and thicknesses or other categories of input parameters, such as welding schedule parameters), expanding the input space further, and in turn further expanding the machine learning flow and architecture.

### Performance of Machine Learning Model

Table 1 below shows a summary of exemplary weld stack-ups analyzed by one embodiment of an extensible machine learning model of the present disclosure.

TABLE 1

| Stackup | Number of Welds |
|---|---|
| 0.8 mm X626 - 0.9 mm HDG LCS | 87 |
| 0.8 mm X626 - 1.0 mm HDG LCS | 141 |
| 0.8 mm X626 - 1.2 mm HDG LCS | 5 |
| 0.8 mm X626 - 0.9 mm ZnNi LCS | 18 |
| 0.8 mm X626 - 0.9 mm ZnNI LCS NO P/L | 15 |
| 1.2 mm 6022 - 1.0 mm HDG LCS | 23 |
| 1.2 mm 6022 - 1.2 mm HDG LCS | 77 |
| 1.2 mm 6022 - 2.0 mm HDG LCS | 123 |
| 1.2 mm 6022 - 1.2 mm HDG CR2 | 22 |
| 1.2 mm 6022 - 1.2 mm HDG CR21082 | 42 |
| 1.2 mm 6022 - 1.2 mm HDG DP600 | 4 |
| 1.2 mm 6022 - 1.2 mm HDG HSLA 340LA | 22 |
| 1.2 mm 6022 - 2.0 mm Bare LCS | 22 |
| 1.2 mm 6022 - 2.0 mm EG LCS | 9 |
| 1.2 mm 6022 - 2.0 mm GA LCS | 13 |

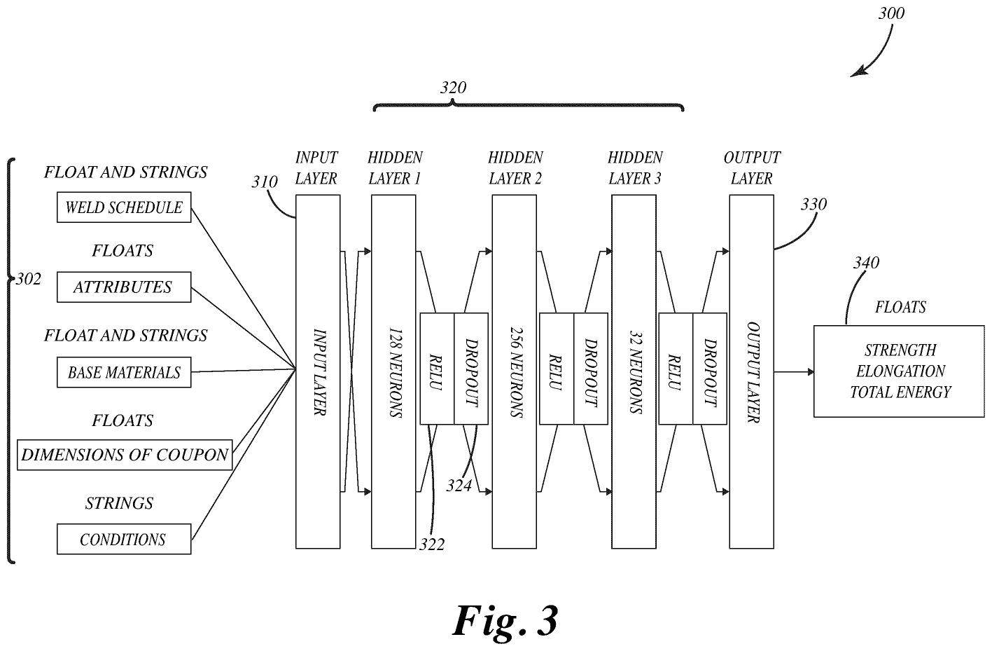

FIG. 4A-B illustrate box plots showing the population distribution for error of prediction for the weld mechanical properties (peak load, extension at break, and total energy), respectively, for both machine learning training and validation testing.

Table 2 below shows a summary of the mean absolute accuracy of machine learning prediction for the mechanical performance properties during both training and testing of this exemplary embodiment.

TABLE 2

| | | Extension | |
|---|---|---|---|
| MAA | Peak Load | at Break | Total Energy |
| Training | 0.915 | 0.870 | 0.851 |
| Testing | 0.898 | 0.858 | 0.811 |

Systems and methods of the present disclosure can predict weld quality for a wide range of material thickness and types (e.g., Aluminum and Steel combinations), as well as materials with different types of surface coatings, e.g., hot dip galvanized (HDG), electro-galvanized (EG), and galvanized annealed (GA). The box plots in FIGS. 4A-B show the population distribution for error of prediction (EoP), e.g., calculated as (ŷᵢ−yᵢ)/yᵢ, where yᵢ is the measured value, and ŷᵢ is the machine learning architecture predicted value, for joint mechanical performance of peak load, extension at break, and total energy, respectively. Note, for this exemplary explanation, each weld stack-up contains tens or hundreds of welds that were fabricated through different weld processes. The narrow boxes of EoP for peak load, extension at break, and total energy indicate that machine learning prediction yields good prediction accuracy with about 50% population of resistance spot welds located around the median of near-zero EoP. Beyond the boxes, the population of RSWs gradually reduces with the increased EoP. As shown in Table 2, the mean absolute accuracy for peak load, extension at break, and total energy is calculated as 91.5%, 87.0%, and 85.1% for training, and the DNN model maintains good accuracy of 89.8%, 85.8%, and 81.1% for peak load, extension at break, and total energy, when the machine learning model was generalized to the unseen validation testing dataset. The consistent accuracy between training and validation testing indicates that the deep neural network architecture is appropriately designed with neither overfitting nor underfitting of the analyzed experimental data.

### Additional Aspects

In a first aspect, a machine learning based method is configured to determine weld quality and properties of resistance spot welds of steel to steel, and steel to aluminum combinations, wherein data from weld schedule, weld attributes, weld electrode and machine conditions, workpiece geometry, and material stack-ups are used for establishing correlation and for prediction.

In a second aspect, the predicted weld quality and properties include peak strength, elongation at break, and total energy at break.

In a third aspect, the data noted in the first aspect includes measurable values of the following variables: electrode force applied on the stacking material sheets, electric current, heating time, and cool time of pre-heat stage, process parameters for each weld stage, e.g., number of pulses, initial current intensity, ending current intensity, heat and cool time per pulse, and cool time over the course of all pulses of each weld stage, shape and dimension of anode and cathode caps, minimum, maximum, and average length across button retained on post fractured specimens, as shown by fractographies of Al-steel welds in FIG. 2C, material indentation formed due to pressure and heat during RSW, which is shown in cross-section view of a RSW in FIG. 2F, expulsion formed due to excessive heat; it is a categorical variable, where 0, 1, and 2 represents there is none, slight, and heavy expulsion, respectively, diameter of Al nugget, distribution and variation of IMC between Al and steel, including mean and maximum IMC thickness, width of its spatial distribution, enclosed area of IMC thickness-spatial distribution curve, as shown in FIG. 2D, zone-based hardness for different locations of RSWs, including hardness of Al nugget, Al HAZ, Al base material, heated zone of steel, as well as base material of steel, as the hardness shown in FIG. 2E, thickness of Al and steel sheets, base material properties, i.e., resistivity, Young's modulus, yield strength, ultimate tensile strength, elongation of both Al and steel alloys, type of coating on steel, geometry dimensions of coach peel specimens, as the dimensions shown in FIG. 2B, categorical variables representing whether the RSW was fabricated with adhesive, baking, ELPO or not, and aging period.

In a fourth aspect, the variables noted in any one of the previous aspects are further grouped into the following categories and representations for use in deep neuron network-based machining architecture, based on their nature and physical meanings: floating point number, integer, and binary categories.

In a fifth aspect, the machine learning based prediction method noted in any one of the previous aspects uses deep neuron network with self-learning capability expandable to additional material combinations.

### Machine Learning Model to Associate the Weld Attributes to Joint Performance

More details will now be provided about the machine learning model that associates weld attributes (and other categories of resistance spot weld input parameters) to joint performance. This description of an exemplary embodiment is provided within the context of utilizing the present disclosure to predict the robustness of dissimilar material joints between Al alloys and steels, which can be challenging. A significant barrier to achieving optimal and repeatable joint performance is insufficient knowledge and understanding of the relationship among welding process, joint attributes, and joint performance governing dissimilar material resistance spot welds of Al and steel alloys.

A deep neural network can automatically explore nonlinear relationships through training lends itself as a suitable method. In the current embodiment, a supervised DNN regression model approach establishes a quantitative correlation between weld attributes and joint performance. The DNN regression model was designed with a multi-layer feed-forward neural network to make associations between independent predictors and joint performance, as shown in the model flowchart shown in FIG. 1.

The independent predictors analyzed included certain weld quality attributes, e.g., weld button size, weld surface indentation, state of expulsion, weld nugget size, IMC thickness, hardness, material information, e.g., base material (BM) of steel and Al alloys, surface coating conditions, weld coupon dimensions, and other conditions, e.g., post-weld baking, aging, stack-up conditions. Performance properties in the form of coach peel test metrics, such as peak load, extension at break, total energy were dependent variables, which formed a triple-object DNN model. The model utilizes one neural network design and one training strategy for all material combinations and weld stack-ups. Such a unified design can benefit comprehensive learning as the model expands to cover more weld stack-ups, base materials, welding conditions, etc. The unified and expandable ML architecture also can facilitate guiding RSW development with “untested” materials, thickness, and other conditions.

By designing data representations with support of welding physics knowledge and interpreting results of machine learning analysis provides insights for resistance spot welding of Al with steel alloys. The physics-guided data representation was prepared for weld attributes, base materials, and other weld conditions to allow the DNN model to gain physical insights of dissimilar Al-steel RSWs. A mean square error loss function can be adopted to evaluate the neural network's performance in predicting joint performance properties. During training, a loss function is propagated backward to compute a gradient of loss function with respect to weights of the network and update the weights following the gradient descent in such a way that minimized the error of prediction. While the analyzed variables were from various categories, there existed one to two orders of magnitude difference among different data streams. Training a model using such data can lead to an unstable network with large node weights. To improve the convergence and training stability, the Minimum-Maximum normalization was applied on the analyzed variables, e.g., data rescaled to the range of [0, 1] through x̅ⁱ=(xⁱ−xₘᵢₙⁱ)/(xₘₐₓⁱ−xₘᵢₙⁱ), where xⁱ represents an input data stream, xₘᵢₙⁱ and xₘₐₓⁱ denote the minimum and maximum of the data stream, and x̅ⁱ is the corresponding normalized data, which encourages a more balanced weighting of neurons and ensures that the gradient descent moves smoothly towards the minima. The normalized independent variables are fed into the DNN model to predict three joint performance properties: peak load, extension at break, and total energy.

The training process for the neural network can be conducted using essentially any suitable deep neural network training software. In the current embodiment, the training was conducted using the Pytorch library, which is an open-source machine learning library developed by Facebook's AI Research lab (FAIR). To further aid in the explanation of the machine learning architecture, herein a specific aspect of Al-steel dissimilar resistance spot welding is descried—the effect of post-weld baking on joint performance—by combining the DNN modeling to identify variables affecting the joint performance and applying finite element (FE) modeling to determine the root causes of correlation identified by DNN modeling.

### Application of DNN Model to a Comprehensive RSW Dataset

In one embodiment, a DNN model is applied to analyze a large dataset, including over 5000 welds, of dissimilar Al-steel resistance spot welds collected over several years of research and testing, which included over 20 different material combinations and hundreds of welding conditions. Data described below covered welds fabricated from two types of Al alloys (X626, 6022) and different steel alloys (Low Carbon Steels (LCS), High Strength Low Alloy (HSLA) steels, Dual Phase (DP) steels) with various types of surface coatings (Hot-Dip Galvanizing (HDG), ZnNi, Electrogalvanized (EG), Galvannealed (GA), bare material). For notation, a weld stack-up was defined as a group of welds which were made by the same thickness combination of one Al alloy and one steel alloy. Each weld stack-up comprised tens to hundreds of welds which were fabricated through different process parameters and possessed varying joint attributes and performances. The DNN model was utilized to analyze the dataset with an emphasis on the relationships between weld attributes, post-weld conditions, and joint performance. Particularly, the influence of post-weld baking is described in detail, as the thermal excursion during post-weld baking can induce microstructural and property changes of the Al alloys and steels as well as at the joint interface, all of which can impact the weld performance.

The experimental data was standardized and transformed into readable formats for machine learning analysis through knowledge-guided quality assurance. As an example, Table 3 lists the measurement data for a resistance spot weld made between 1.2 mm thick AA6022 and 1.2 mm thick HDG LCS. That is, Table 3A shows experimental measurement of weld attributes and joint performance properties for a 1.2 mm AA6022-1.2 mm HDG LCS RSW (7 replications) under coach peel tests, Table 3B shows selected feature variables for IMC thickness variation (unit: μm), and Table 3C shows selected feature variables of zone-based hardness (unit: Hv).

TABLE 3
(a)

| | | | | | | Joint performance | | |
|---|---|---|---|---|---|---|---|---|
| | Weld attributes | | | | | properties | | |
| Index of | | | | | Material | Peak | Extension | Total |
| replicated | Button size (mm) | | | Internal | Indentation | load | at break | energy |
| specimen | Min | Max | Avg | expulsion | (mm) | (N) | (mm) | (J) |
| 1 | 5.4 | 6 | 5.7 | N | 0.5 | 483 | 26.43 | 8.89 |
| 2 | 6.8 | 6.9 | 6.9 | N | 0.5 | 415 | 24.8 | 7.23 |
| 3 | 6.7 | 6.9 | 6.8 | N | 0.5 | 447 | 26.43 | 7.92 |
| 4 | 5 | 6 | 5.5 | IXS | 0.63 | 338 | 18.33 | 4.93 |
| 5 | 6.2 | 6.6 | 6.4 | N | 0.5 | 444 | 25.03 | 7.79 |
| 6 | 4 | 5.3 | 4.7 | IXS | 0.5 | 434 | 24.8 | 7.45 |
| 7 | 6.4 | 6.4 | 6.4 | IXS | 0.51 | 439 | 23.76 | 7.62 |

(b)

| | Nugget | Mean | Maximum | IMC |
|---|---|---|---|---|
| | diameter | thickness | thickness | enclosed area |
| Average | 8004.67 | 1.47 | 2.39 | 12,167.2 |
| STDEV | 82.32 | 0.02 | 0.26 | 517.86 |

(c)

| | | Al HAZ | Al | Steel | Steel |
|---|---|---|---|---|---|
| | Al BM | minimum | nugget | BM | nugget |
| Average | 75.25 | 71.54 | 64.44 | 89.97 | 113.91 |
| STDEV | 1.92 | 0.83 | 2.17 | 1.32 | 2.39 |

The weld attributes, including button size, material indentation, expulsion, intermetallic compound (IMC), and hardness formed during resistance spot welding, were measured by metallographic and metallurgical analysis. Those weld attributes collectively influence the weld performance, and they were implemented together with material information (material classification, surface coating, dimensions) and other conditions (post-weld baking, aging, stack-up conditions) as independent variables to assess the mechanical performance of Al-steel resistance spot welds. Joint performance tests were performed on seven replicated samples for the weld quality and repeatability study, while the IMC and hardness measurements were collected from another three replicated weld samples. The feature extraction was performed for IMC thickness and hardness with guidance grounded in welding physics to represent their distribution characteristics, and then the averaged feature variables of IMC and hardness (as listed in Table 3B-C) were assigned as group variables to label the mechanical test samples for subsequent training and testing the DNN model (each mechanical test sample as an independent data set). A total number of 2212 labeled data sets for Al-steel welds were prepared for machine learning analysis. The labeled data sets were then randomly categorized into training and validation testing, with the ratio of 8:2 (training:testing).

### Performance of ML Model

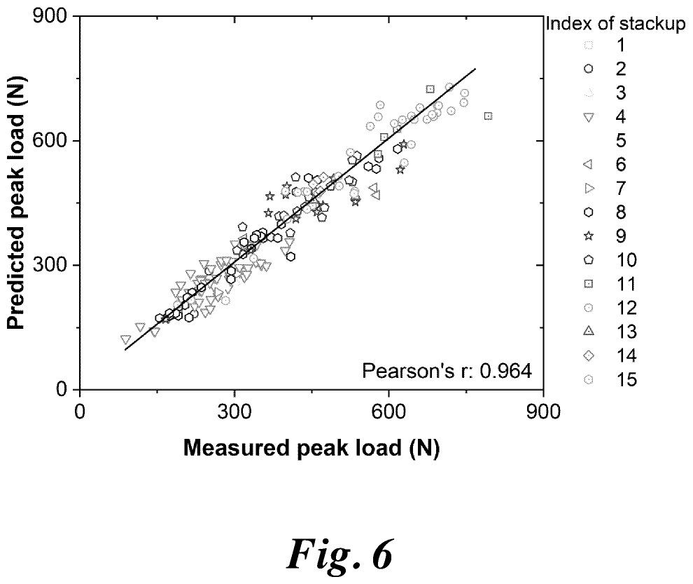

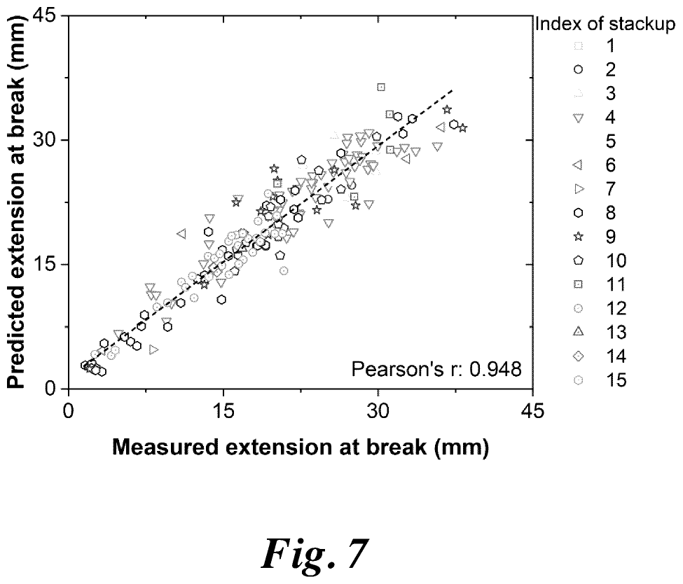

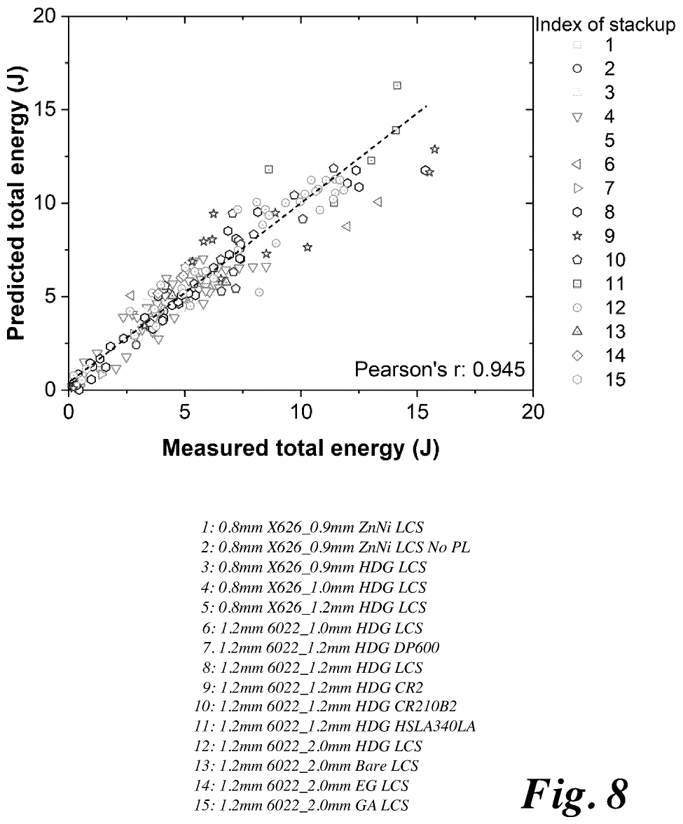

To illustrate the effectiveness of the resistance spot weld deep neural network model, the machine predicted joint properties are compared to experimental measurements. FIGS. 6-8 show results of a regression analysis between the measured and ML predicted peak load (FIG. 6), extension at break (FIG. 7), and total energy (FIG. 8) for validation testing welds.

The predicted and measured values are located around the perfect prediction line (i.e., y=x) in a scattered manner. The Pearson's correlation coefficients between the measured and predicted values for peak load, extension at break, and total energy are calculated as 0.964, 0.948, and 0.945, respectively. The high correlation coefficients suggest a strong relationship between predicted and measured data, that is, the DNN regression model identified the high dimensional correlations among the welds attributes, post-weld condition and mechanical properties of RSW joints. The performance metric mean absolute prediction accuracy (MAPA) quantifies the model's prediction accuracy. The MAPA is the percentage representation of mean absolute accuracy and calculated as (1−1/NΣᵢ₌₁^{N}|(yᵢ−ŷᵢ)/yᵢ|)×100%, where yᵢ is the measured joint performance of i^{th} sample, ŷᵢ is the corresponding ML predicted value, and N is the total number of welds in the validation testing data set. The MAPA is 90.6%, 85.2%, and 79.9% for peak load, extension at break, and total energy, respectively. These analyses suggest that the DNN model is reliable and accurate in predicting and analyzing the mechanical performance of dissimilar Al-steel resistance spot welds.

### Thickness-Dependent Baking Effects Identified by the Machine Learning Model

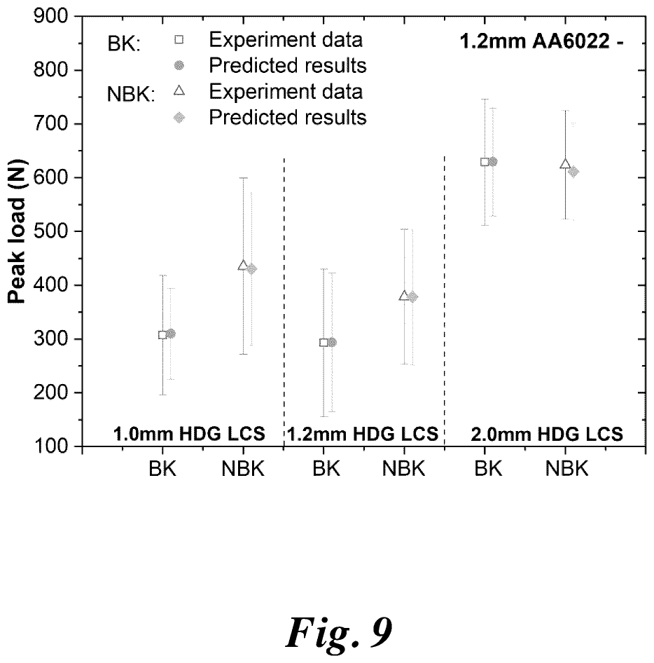

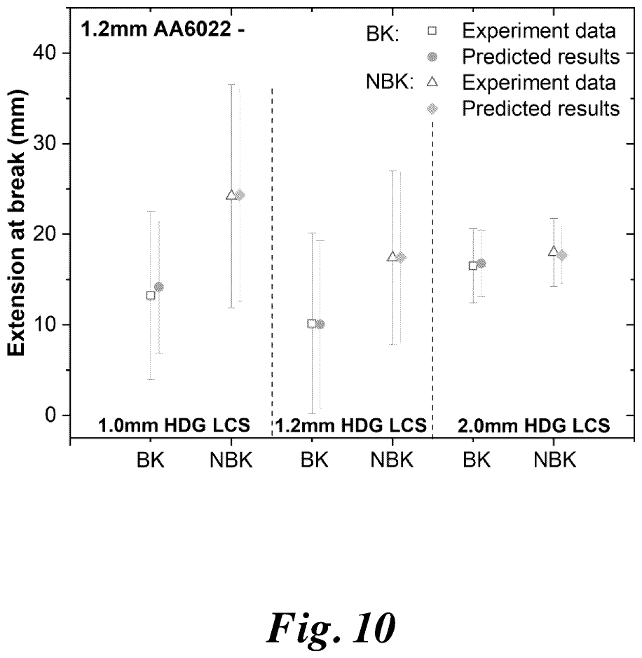

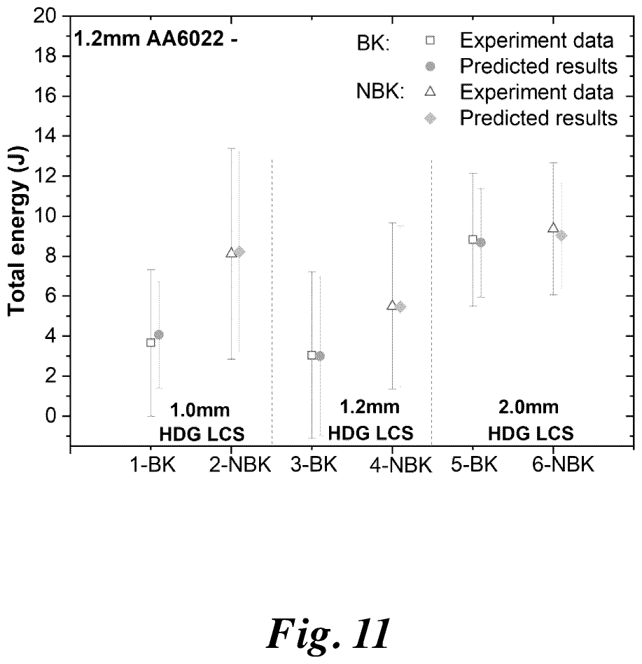

One step of automotive production, paint baking, is used to cure coatings and adhesives after the auto body parts are welded together. The machine learning model can identify, with high confidence, several variables that influence the post-weld baking joint performance of dissimilar Al-steel resistance spot welds. The results of one material combination (AA6022-LCS) are used, as an example, to illustrate the correlation identified by an exemplary machine learning model in accordance with the present disclosure. FIGS. 9-11 show differences in joint performance (peak load (FIG. 9), extension at break (FIG. 10), and total energy (FIG. 11)) of the unbaked welds and the corresponding paint baked welds. That is, the results of the machine learning DNN analysis illustrates the thickness-dependent baking effect on joint performance of peak load, extension at break, and total energy for an exemplary dissimilar AA6022-LCS resistance spot weld.

The machine learning model identifies the correlation of steel sheet thickness on the differences in joint performance between the unbaked and baked weld, which is confirmed by the experimental measurements. The post-weld baking results in significant reduction (averages ranging from 29% to 55%) of peak load, extension at break, and total energy in 1.2 mm AA6022-1.0 mm HDG LCS spot welds. As the thickness of steel sheet increased, the baking-induced performance reduction gradually subsided. The effect of baking became negligible for resistance spot welds in stack-ups containing 2.0 mm thick steel. Overall, the machine learning model predicts that the post-weld baking resulted in a degraded joint performance of Al-steel spot welds and that the degree of degradation exhibited an inverse dependence on the thickness of the steel alloy within the dissimilar material stack-up. Further, according to the experimental data, paint baking increases the hardness of AA6022. For example, the hardness of AA6022 increased from approximately 74 MPa to 82 MPa in the base metal, from 64 MPa to 67 MPa in the weld nugget, and from 72 MPa to 80 MPa in the HAZ on average. Given this one would expect an increase of weld strength post paint baking. However, the opposite is true which suggests that the baking effect on the constituent materials alone is insufficient to explain the reduced performance of dissimilar Al-steel RSWs, and the distinct physical and metallurgical properties of the Al and steel alloys should be considered.

Mechanistic Understanding of Baking Effects with the Finite Element Model

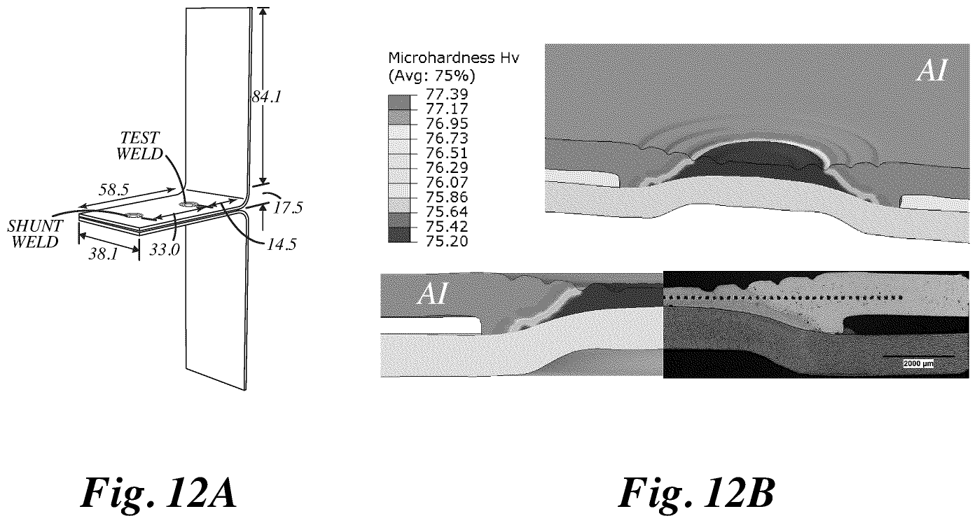

A three-dimensional (3-D) model can be constructed based on the coach peel specimen configuration, as shown in FIGS. 12A-B. Specifically, FIG. 12A illustrates a schematic of a finite element model of a coach peel weld specimen including geometry dimensions (unit: mm), and FIG. 12B illustrates a hardness informed model with nugget area mapped from the cross-section geometry. The details of the testing weld were mapped from the photography of the polished cross section to capture the material thinning and structural change due to resistance spot welding, as shown in FIG. 12B. The mechanical properties of Al alloy 6022-T4 and HDG LCS, together with the coefficient of thermal expansion (CTE) are listed in Table 4.

TABLE 4

| | | | Ultimate | | Coefficient |
|---|---|---|---|---|---|
| | Elastic | Yield | Tensile | | of Thermal |
| | Modulus | Strength | Strength | Elongation | Expansion |
| Material | (GPa) | (MPa) | (MPa) | (%) | (K⁻¹) |
| AA6022-T4 | 70 | 172 | 282 | 26.7 | 25.8 × 10⁻⁶ |
| HDG LCS | 207 | 138 | 275 | 60.7 | 11.3 × 10⁻⁶ |

The hardness measurement represents the material strength of different locations across the weld, as the contour plot shows in FIG. 12B. Since the thermal cycles inherent in the weld schedule altered the material microstructure and properties, the hardening behavior of the HAZ and nugget of Al-steel welds was unknown. Herein, the hardening behavior in Al HAZ and nugget was estimated by assuming that both the yield and ultimate tensile strength were linearly proportional to hardness. For simplicity the same elastoplastic property was assumed for the entire steel side including the base metal, HAZ and weld nugget. Based upon metallographic analysis of the polished weld cross-sections, the IMC was approximated as a uniformly thin layer (approximately 4 μm thick) between Al and steel plates. The elastic modulus of Fe—Al IMC was taken as 230.5 GPa and CTE was about 6˜10×10⁻⁶ K⁻¹ at room temperature. Since temperature-dependent material properties for the HAZ and nugget are not readily available, the material properties at room temperature were used to simulate the deformation behavior of the spot weld during baking process.

In the 3-D finite element model, the weld coupon was heated from room temperature to 175° C. to simulate the paint baking effect. In the experimental tests, the weld coupon had one testing weld and one anchor weld. During baking, the deformation and stress in the testing weld can be influenced by the presence of the anchor weld since it imposes a strong constraint on the expansion of the two sheets composing the stack-up. To differentiate the influence caused by baking and the presence of the anchor weld, two weld configurations were prepared and examined in the following finite element analysis: one with a single testing weld (single joint specimen) and the other with both a testing weld and an anchor weld (double joint specimen same as the coach peel test specimen). In the following simulations, stress-free conditions were assumed as the initial states of welds, aimed to directly study the stresses caused by post-weld baking process.

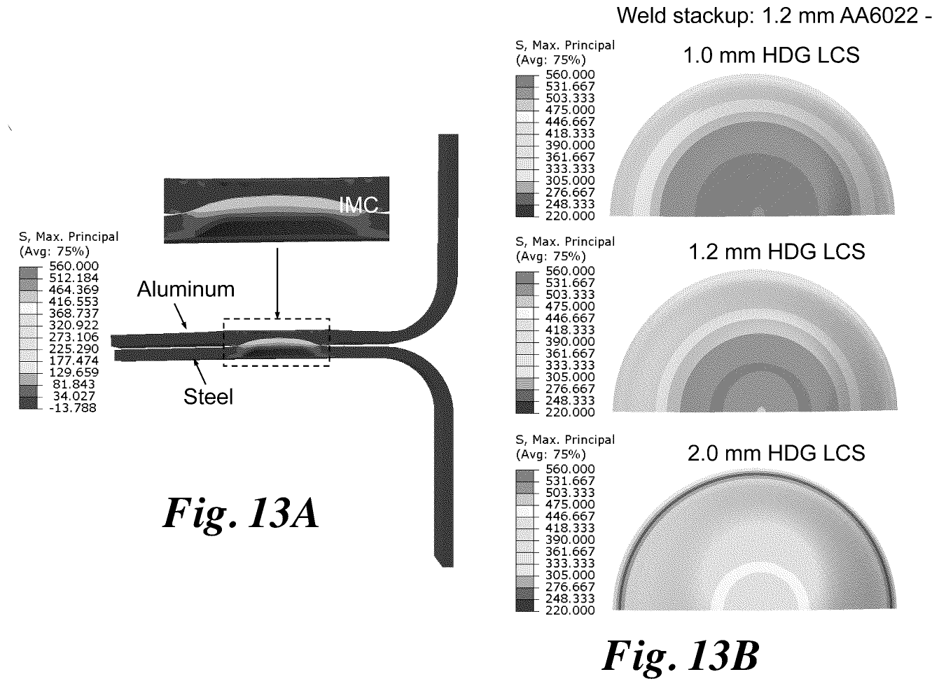

FIGS. 13A-B shows a schematic of the simulated stress distribution in the single joint specimen for 1.2 mm AA6022 and 1.2 mm HDG LCS at the baking temperature of 175° C. Specifically, FIG. 13A shows thermal stress distribution in a single joint RSW specimen and FIG. 13B shows the variation of thermal stress in IMC layer with increased thickness of steel plate under baking process.

The deformation of the specimen was amplified by a factor of 10 for better visualization. As can be observed in FIG. 13A-B, the aluminum sheet expanded significantly more than both the IMC layer and steel sheet, because of its relatively greater thermal expansion coefficient. This created a substantial deformation mismatch among Al alloy, IMC, and steel, and accordingly led to the formation of high thermal stresses at the faying interface within the IMC layer, as shown in FIG. 13B. The stress generally concentrated at the midpoint of the IMC layer, i.e., approximate center of the weld, and gradually decreased towards the periphery of the IMC layer. The principal direction of the thermal stresses was within the plane of the IMC layer. Such high in-plane thermal stresses can cause crack formation within the IMC layer. Upon cooling of the sample, these defects can act as low energy crack paths leading to reduced joint strength by promoting undesirable interfacial fracture under externally applied loads. The deduction from the above mechanistic simulation was evidenced by an in-situ SEM study of baked AA5754-LCS RSWs. To date there are limited studies discussing the baking effects on dissimilar material RSWs and even fewer addressing welds with different material thickness combinations. In the above machine learning analysis, it was illustrated that the baking induced degradation of joint performance and the resultant influence exhibited a strong dependence on the thickness of stacking materials. To gain an understanding of the mechanics underlying this phenomenon, finite element simulations were performed of two-sheet RSWs for three material thickness combinations. The contour plots of FIG. 13B are the simulated stress distribution within the IMC layer for the three material combinations. A relatively high thermal stress can be observed within the IMC layer of the thinner steel sheet containing welds. This peak stress level is reduced as the thickness of steel sheet increases which is attributed to the thicker steel sheet contributing to an enhanced structural stiffness which provided greater resistance to the thermal expansion deformation of the Al sheet during the baking process. Accordingly, the deformation mismatch between Al, IMC, and steel was suppressed, and the thermal stresses became less prominent which was insufficient to trigger crack formation in the IMC layer. These numerical simulations help identify the thermal expansion mismatch between Al and steel alloys as the primary factor for the deteriorated joint performance caused by post-weld baking and the mechanistic origin for the material thickness dependent behavior.

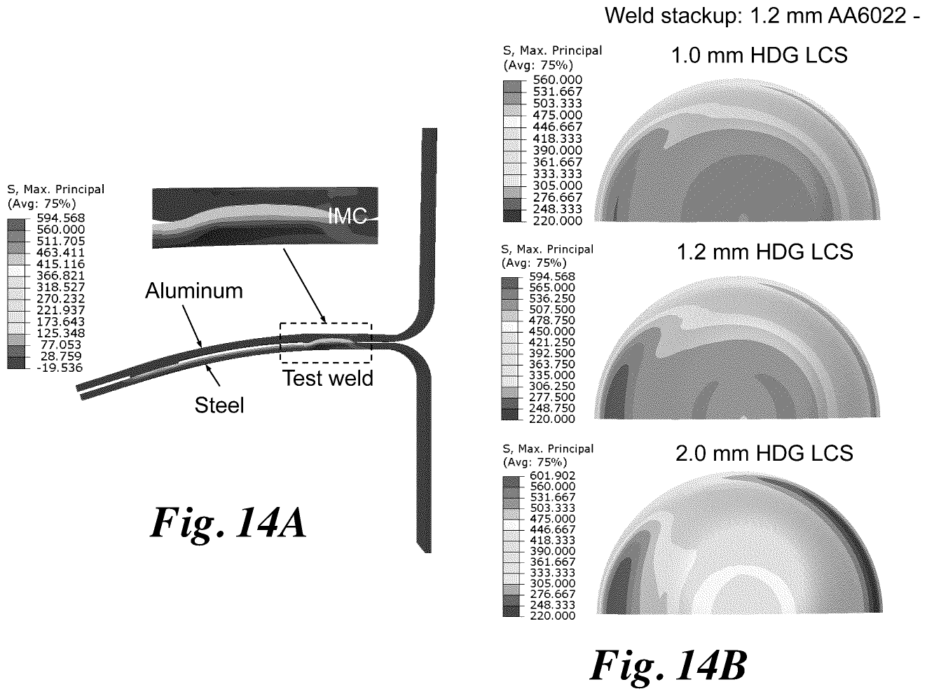

The post-weld baking process can also be simulated on a double joint specimen to show influence created by an anchor weld. FIG. 14A shows a plot of simulated stress distribution in a resistance spot weld composed of 1.2 mm AA6022 and 1.2 mm HDG LCS at the end of baking (applied deformation amplifier factor of 10). FIG. 14B shows variation of thermal stress in IMC layer with increased thickness of steel plate under baking process.

The double joint specimen exhibits significant bending deformation in contrast to a single joint specimen (Refer to FIG. 13A). This is generally attributed to the presence of the anchor weld imposing a strong constraint which retards the fast expansion of the Al sheet within the stack-up. Consequently, the stress distribution on the IMC layer is also altered due to the anchor weld, refer to FIG. 14B. Instead of the axisymmetric stress distribution in the single-joint weld, high thermal stress was also generated in the region between the welds. With increasing steel sheet thickness, the relatively high thermal stresses in the central region of the IMC gradually released, while the off-center stresses concentration remained unchanged. Such high stresses can induce cracking of the IMC, nevertheless, they can be secondary for the overall RSW performance, as its location is generally opposite to the direction of the primary external load in the coach peel test. In general, high thermal stresses will not influence the crack initiation in a button pullout fracture regime, but they can affect cracking behavior during a later stage of propagation by providing a lower energy path to form interfacial fracture as the crack approached that area. In short, the presence of an anchor weld can induce different stress distributions at the faying interface.

By utilizing machine learning and finite element analysis to investigate the effect of post-weld baking on mechanical performance of dissimilar Al-steel RSWs, it provides support for the unified and expandable machine learning architecture of the systems and methods of the present disclosure.

The machine learning model with a unified deep neural network architecture can predict joint performance based upon the weld attributes, stacking materials, and other conditions for a wide range of material combinations and weld stack-ups, with an average prediction accuracy for peak load, extension at break, and total energy of 90.6%, 85.2%, and 79.9%, respectively.

The DNN model can identify relationships between certain resistance spot weld input parameters and output parameters (e.g., that post-weld baking reduces the joint performance, and the extent of degradation is inversely proportional to the thickness of the steel sheet within the stack-up).

The finite element analysis simulates the behavior of dissimilar Al-steel RSWs during baking process and confirms that a root cause for the effect of post-weld baking is the formation of high thermal stresses at the faying interface, caused by the mismatch of thermal expansion strain between steel and Al alloy. While the finite element analysis is not a necessary component of the systems and methods of the present disclosure, it helps to support and explain how the machine learning architecture can accurately predict weld quality and other weld characteristics. Such high thermal stresses can damage the relatively brittle intermetallic phase at the interface for the deteriorated joint performance caused by post-weld baking. The thickness of the steel sheet and presence of adjacent spot welds strongly influence the thermal stress distribution at the interface, which in turn can alter the extent of damage of intermetallics and associated material thickness dependent behavior.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A system comprising:
a data storage system configured to store a deep neural network (DNN) model pretrained to:
receive input parameters for a resistance-spot welding (RSW) system, wherein the input parameters have categories comprising base materials, attributes, coupon geometries, condition, and schedule, and
predict two or more joint-performance metrics of a joint of two dissimilar materials to be produced by the RSW system using the input parameters;
a computer system configured to:
retrieve the pretrained DNN model from the data storage system,
access (i) sets of experimental input parameters used by the RSW system to produce respective joints of pair-wise dissimilar materials, and (ii) sets of experimental joint-performance metrics corresponding to the produced joints,
normalize the experimental input parameters and the experimental joint-performance metrics in a manner expected by the pretrained DNN model,
retrain the DNN model using the normalized experimental input parameters and the normalized experimental joint-performance metrics, and
instruct the data storage system to store the retrained DNN model; and
controller circuitry configured to:
receive one or more new input parameters to be included in the input parameters that, when used by the RSW system to join two dissimilar materials, cause the RSW system to produce a new joint having two or more target joint-performance metrics,
retrieve, from the data storage system, the retrained DNN model and use it to determine remaining input parameters to be used by the RSW system in conjunction with the new input parameters to produce the new joint having the target joint-performance metrics, and
instruct the RSW system to use as input parameters the new input parameters and the determined input parameters to join the two dissimilar materials.

2. The system of claim 1, wherein the two materials to be joined by the RSW system comprise one of:
an Al alloy and a steel, or
a first steel and a second steel, or
a first Al alloy and a second Al alloy.

3. The system of claim 1, wherein
the base materials category comprises one or more of
thickness parameters,
base material type parameters, or
coating parameters,
the attributes category comprises one or more of
button size parameters,
nugget size parameters,
IMC parameters,
hardness parameters,
indentation parameters, or
expulsion parameters,
the coupon geometries category comprises dimensions of coupon,
the condition category comprises one or more of
adhesive parameters,
baking parameters,
aging parameters, or
ELPO parameters, and
the schedule category comprises one or more of
pre-heating parameters,
phase parameters,
electrode cap parameters, or
clamp load parameters.

4. The system of claim 1, wherein the joint-performance metrics comprise
a measured peak load,
a measured extension at break, and
a total energy.

5. The system of claim 1, wherein the computer system comprises one or more of
a personal computer, or
a supercomputer system.

6. The system of claim 1, wherein the DNN model is a physics-driven, unified, expandable architecture including an input layer, three or more hidden layers, and an output layer.

7. The system of claim 1, wherein the DNN model is configured to include one or more input layer neurons corresponding to input parameters from each of the following five resistance spot weld input parameter categories: weld schedule, weld attributes, base materials, coupon geometry, and weld condition, and one or more output layer neurons corresponding to output parameters from each of the following three resistance spot weld output parameter categories: peak load, extension at break, and total energy.

8. The system of claim 7, wherein the DNN model further includes three or more hidden layers between the input layer and output layer, and wherein the DNN model further includes a rectified linear unit layer and a dropout layer between each of the hidden layers and before the output layer.

9. The system of any one of claim 1, wherein the DNN model is configured to include one or more input layer neurons corresponding to input parameters from each of the following four resistance spot weld input parameter categories: weld attributes, base materials, coupon geometry, and weld condition, and one or more output layer neurons corresponding to output parameters from each of the following three resistance spot weld output parameter categories: peak load, extension at break, and total energy.

10. The system of claim 1, wherein the computer system includes
a deep neural network (DNN) training component configured to receive a DNN spot resistance welding test dataset and a DNN spot resistance welding validation dataset, the DNN training component configured to train a spot resistance welding DNN machine learning model as a function of the DNN spot resistance welding test dataset, the DNN training component includes a DNN validation component configured to validate the spot resistance welding DNN machine learning model as a function of the DNN validation dataset; and
a DNN processing component configured to receive a new spot resistance weld dataset representing spot resistance parameters for generating a spot resistance weld with a spot resistance welding machine, and to process the new spot resistance weld dataset to predict weld quality associated using the validated spot resistance weld DNN machine learning model.

11. The system of claim 1, wherein the controller circuitry is configured to use the retrained DNN model to determine remaining input parameters to be used by the RSW system in conjunction with the new input parameters to produce the new joint having the target joint-performance metrics.

12. The system of claim 1 comprising an RSW system that includes the controller circuitry.

13. The system of claim 1, comprising an RSW system that includes the data storage system.

14. A method for determining weld quality, the method including the steps of:
accessing, in memory with a deep neural network (DNN) processing component, a pretrained resistance spot welding deep neural network (DNN) model, the pretrained resistance spot welding DNN model being configured to predict weld quality of a weld joint between two base materials produced by an RSW system based on a set of resistance-spot welding input parameters;
receiving, from a user interface, one or more target weld performance metrics associated with weld quality;
receiving, from a user interface, values for a subset of the set of resistance-spot welding input parameters;
iteratively predicting weld quality of a weld joint between two base materials produced by an RSW system with the pretrained DNN model, using the DNN processing component, by using the received values for the subset of the set of resistance-spot welding input parameters and different values of one or more remaining resistance-spot welding input parameters to determine values for the one or more remaining resistance-spot welding input parameters where the DNN model predicts weld quality that meets the one or more target weld performance metrics;
instructing the RSW system to use as input parameters the received values of the subset of the set of resistance-spot welding input parameters and one of the determined values for the one or more remaining resistance-spot welding input parameters to weld the two base materials.

15. The method of claim 14, wherein the two base materials to be joined by the RSW system comprise one of: an Al alloy and a steel, or a first steel and a second steel, or a first Al alloy and a second Al alloy.

16. The method of claim 14, wherein the subset of the set of resistance-spot welding input parameters includes type of base materials to be welded, thickness of the base materials to be welded, coatings, if any, of the base materials to be welded.

17. The method of claim 14, including receiving, from a user interface, customized ranges for the one or more remaining resistance-spot welding input parameters.

18. The method of claim 14, including identifying a combination of values of input parameters including the received values of the subset of the set of resistance-spot welding input parameters and a range of values for the one or more remaining resistance-spot welding input parameters that the DNN model predicts will cause an RSW system to produce a weld joint with the target weld performance metrics.

19. The method of claim 14, wherein the DNN model is a physics-driven, unified, expandable architecture including an input layer, three or more hidden layers, and an output layer, and wherein the DNN model further includes a rectified linear unit layer and a dropout layer between each of the hidden layers and before the output layer.

20. The method of claim 14, wherein the DNN model is configured to include one or more input layer neurons corresponding to input parameters from each of the following five resistance spot weld input parameter categories: weld schedule, weld attributes, base materials, coupon geometry, and weld condition, and one or more output layer neurons corresponding to output parameters from each of the following three resistance spot weld output parameter categories: peak load, extension at break, and total energy.
